(19) United States
(12) Patent Application Publication
(10) Pub. No.: US 2020/0179946 A1
(43) Pub. Date: Jun. 11, 2020

(54) FILTERING DEVICE

(71) Applicant: DONG IL TECHNOLOGY LTD., Hwaseong (KR)

(72) Inventors: Kyeong Soo YU, Ansan (KR); Kyeong Jun JO, Siheung (KR); Kyung Soo MIN, Gunpo (KR); Min Ki SON, Hwaseong (KR)

(73) Assignee: DONG IL TECHNOLOGY LTD., Hwaseong (KR)

(21) Appl. No.: 16/483,047

(22) PCT Filed: Feb. 5, 2018
(86) PCT No.: PCT/KR2018/001503

§ 371 Date: Aug. 2, 2019

(30) Foreign Application Priority Data
Feb. 3, 2017 (KR) 10-2017-0015566
Feb. 3, 2017 (KR) 10-2017-0015573

(51) Int. Cl. B03C 3/38; B03C 3/66; B03C 3/41; B03C 3/51; B03C 3/82

(52) U.S. Cl. CPC B03C 3/38; B03C 3/66; B03C 2201/04; B03C 3/51; B03C 3/82; B03C 3/41

(57) ABSTRACT

Disclosed is a filtering device for removing fine dust, the filtering device comprising: a charger including a case having one side, through which fine dust is introduced, a plurality of beam electrodes inserted into the case and spaced apart from each other along a depth direction of the case, line electrodes arranged inside the case and spaced apart from the plurality of beam electrodes, respectively, and a dust collector including a first dust collecting electrode to which a first dust collecting voltage is applied, a second dust collecting electrode to which a second dust collecting voltage is applied to generate a voltage difference with the first dust collecting electrode and a dielectric spacer disposed between the first dust collecting electrode and the second dust collecting electrode to space the first dust collecting electrode and the second dust collecting electrode apart from each other and to serve as a dielectric.

### TECHNICAL FIELD

The present invention relates to a filtering device for removing dust or contaminants, and more particularly, to a filtering device having a structure in which a charger and a dust collector are improved.

### BACKGROUND ART

Recently, as the air pollution due to fine dust or smog is getting worse, there has been growing attention to devices, such as, for example, an air cleaner for removing fine dust particles.

Such devices include a filtering device to remove dust or pollutants from ambient spaces. The filtering device includes a charger charging the fine dust and a dust collector collecting the charged fine dust.

A general charger, including one electrode and the other electrode having a relatively large width, electrically charges fine dust existing between the both electrodes. Here, the smaller resistance, the more current flows. Thus, the charger intensively charges the fine dust at a region where the distance between the both electrodes is smallest, and relatively mildly charges the fine dust at the other regions. Accordingly, the charging efficiency may be lowered, and the performance of the filtering device may be deteriorated.

In addition, the dust collector may include electrodes for collecting dust, and the charged fine dust can be collected by applying a voltage to the electrodes. The dust collector may become bulky due to the collecting electrodes, and the dust collecting efficiency may be lowered. Therefore, there exists a need for researches to improve the efficiency of the dust collector by making a filtering device compact and improving the performance of a dust collector.

### Technical Problems to be Solved

The present invention has been made in an effort to solve the problems of the prior art, and it is an object of the present invention to provide a charger for a filtering device having a structure in which the efficiency of charging fine dust is improved.

It is another object of the present invention to provide a dust collector for a filtering device having a structure in which the efficiency of collecting the charged fine dust is improved.

It is still another object of the present invention to provide a filtering device having a structure in which the efficiency of charging and the efficiency of collecting the charged fine dust are improved.

### Technical Solutions

In accordance with an aspect of the present invention, the above and other objects can be accomplished by providing a charger employed to a filtering device for removing fine dust and charging the fine dust, the charger including a case having one side, through which fine dust is introduced, a plurality of beam electrodes inserted into the case and spaced apart from each other along a depth direction of the case wherein a first voltage is applied thereto, and line electrodes arranged inside the case and spaced apart from the plurality of beam electrodes, respectively, so that a second voltage is applied thereto to generate a voltage difference with the beam electrodes, wherein the fine dust is charged between the beam electrodes and the line electrodes.

Here, the plurality of beam electrodes may be connected to a plurality of first connection parts, and the plurality of first connection parts may be connected to second connection parts in a state in which the first connection parts are spaced apart from each other to then be arranged along a width direction of the case. The case may include beam electrode insertion parts protruding toward the beam electrodes, and at least one or more of the plurality of beam electrodes may be inserted into grooves of the beam electrode insertion parts.

In addition, the charger may further include a fine dust introduction cover having an introduction hole through which the fine dust is introduced and disposed above the beam electrodes to cover an opening of the case. Here, the case may include holding ledges for preventing the fine dust introduction cover from moving along a depth direction of the case, and passing grooves may be formed in the holding ledges to allow at least one or more of the plurality of beam electrodes to pass therethrough.

In addition, elastic parts may be fixed to the interior surface of the case, and the line electrodes maybe connected to the elastic parts.

In accordance with another aspect of the present invention, the above and other objects can be accomplished by providing a dust collector employed to a filtering device for removing fine dust and collecting the charged fine dust, the dust collector including a first dust collecting electrode to which a first dust collecting voltage is applied, a second dust collecting electrode to which a second dust collecting voltage is applied to generate a voltage difference with the first dust collecting electrode, and a dielectric spacer which is disposed between the first dust collecting electrode and the second dust collecting electrode to space the first dust collecting electrode and the second dust collecting electrode apart from each other and to serve as a dielectric, wherein the dielectric spacer is disposed to contact both surfaces of the first dust collecting electrode and both surfaces of the second dust collecting electrode.

The dielectric spacer may include protrusion parts protruding toward at least one of the first dust collecting electrode and the second dust collecting electrode.

Each of the first dust collecting electrode and the second dust collecting electrode may have a conductive layer attached to both surfaces of a base plate.

The dust collector may further include a dust collecting case in which a plurality of first dust collecting electrodes, a plurality of second dust collecting electrodes and a plurality of dielectric spacers are mounted, wherein the plurality of first dust collecting electrodes and the plurality of second dust collecting electrodes are alternately arranged along a width direction of the dust collecting case.

The dust collector may further include a first bus bar connecting the plurality of first dust collecting electrodes to supply the plurality of first dust collecting electrodes with the first dust collecting voltage, and a second bus bar connecting the plurality of second dust collecting electrodes to supply the plurality of second dust collecting electrodes with the second dust collecting voltage.

The conductive layer may be formed on the base plate of each of the first dust collecting electrode and the second dust collecting electrode, an adhesion layer may be formed on the conductive layer, a film may be formed on the adhesion layer, exposing holes may be formed in the adhesion layer, and cutting lines may be formed in regions of the film corresponding to the exposing holes.

In accordance with still another aspect of the present invention, the above and other objects can be accomplished by providing a filtering device for removing fine dust, the filtering device comprising: the charger having the above-stated configuration for charging the fine dust, and the dust collector having the above-stated configuration for collecting the charged fine dust. Here, the filtering device may further include connection rails including a plurality of filtering modules each having the charger and the dust collector overlapping each other and connecting the plurality of filtering modules to one another, wherein guiding grooves are formed in the connection rails to allow the filtering modules to be inserted thereinto and to slidably move.

### Advantageous Effects

As described above, the charger according to the present invention includes beam electrodes and line electrodes, thereby improving the efficiency of charging fine dust.

In addition, the dust collector according to the present invention includes a first dust collecting electrode, a second dust collecting electrode and a dielectric spacer, thereby improving the efficiency of collecting the charged fine dust.

In addition, the filtering device according to the present invention includes a charger having beam electrodes and line electrodes and a dust collector having first and second dust collecting electrodes and a dielectric spacer, thereby efficiently collecting fine dust.

### BRIEF DESCRIPTION OF DRAWINGS

FIG. 1 is a perspective view of a filtering device according to an embodiment of the present invention.

FIG. 2 is a partly exploded perspective view illustrating a charger in the filtering device according to an embodiment of the present invention.

FIG. 3 is a schematic cross-sectional view illustrating arrangement of line electrodes and beam electrodes in the charger according to an embodiment of the present invention and arrangement of electrodes in a charger according to Comparative Example.

FIGS. 4 to 6 are schematic cross-sectional views illustrating various examples of beam electrodes and line electrodes in the charger according to an embodiment of the present invention.

FIG. 7 is a plan view illustrating portions of elastic parts of the filtering device according to an embodiment of the present invention.

FIG. 8 is an exploded perspective view illustrating that line electrodes fixed to a case of the charger according to an embodiment of the present invention.

FIG. 9 is an exploded perspective view of a dust collector according to an embodiment of the present invention.

FIGS. 10 and 11 are schematic cross-sectional views illustrating arrangements of a first dust collecting electrode, a second dust collecting electrode and a dielectric spacer in the dust collector according to an embodiment of the present invention.

FIGS. 12 and 13 are exploded perspective views illustrating modified examples of the dust collector according to an embodiment of the present invention.

FIG. 14 is a view illustrating modified examples of a first dust collecting electrode and a second dust collecting electrode of the dust collector according to an embodiment of the present invention.

FIG. 15 is an exploded perspective view illustrating an array structure of the filtering device according to an embodiment of the present invention.

### BEST MODE FOR CARRYING OUT THE INVENTION

Hereinafter, a filtering device including a charger and a dust collector according to an embodiment of the present invention will be described in detail with reference to the accompanying drawings.

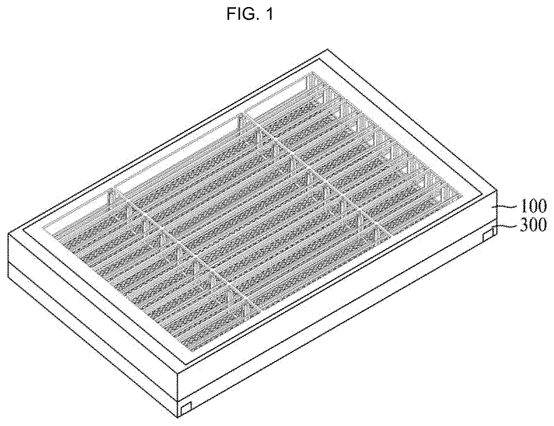

FIG. 1 is a perspective view of a filtering device according to an embodiment of the present invention. Referring to FIG. 1, the filtering device includes a charger 100 and a dust collector 300. The charger 100 electrically charges fine dust introduced thereto to make the fine dust charged. The dust collector 300 collects the charged fine dust.

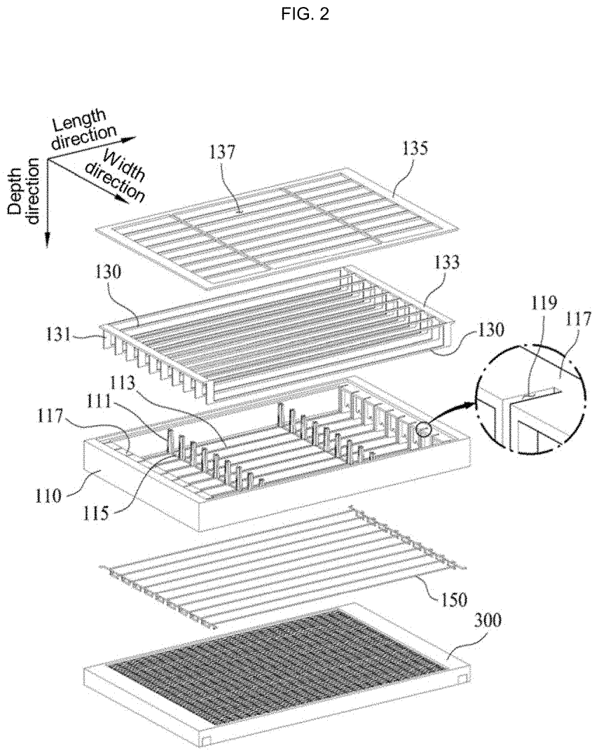

FIG. 2 is a partly exploded perspective view illustrating a charger in the filtering device according to an embodiment of the present invention. Referring to FIG. 2, the charger 100 may include a case 110, beam electrodes 130 and line electrodes 150. The fine dust is introduced to one side of the case 110. T [symbol] he beam electrodes 130 may function as discharge electrodes, and the line electrodes 150 may be opposite electrodes of the discharge electrodes.

The plurality of beam electrodes 130 are inserted into the case 110 to allow a first voltage to be applied thereto and are spaced apart from each other along a depth direction of the case 110. The [symbol] plurality of beam electrodes 130 are connected to first connection parts 131, and a plurality of first connection parts 131 are connected to second connection parts 133 in a state in which the plurality of first connection parts 131 are spaced apart from each other to then be arranged along a width direction of the case 110. The line electrodes 150 are arranged inside the case 110 to allow a second voltage to be applied thereto to generate a voltage difference with the beam electrodes 130, and are arranged to be spaced apart from the plurality of beam electrodes 130, respectively. The line electrodes 150 may include wires made of a conductive material.

The fine dust passing between the beam electrodes 130 and the line electrodes 150, which are arranged along the width direction of the case 110 in the above-described manner, may be electrically charged by a discharge current flowing between the plurality of beam electrodes 130 and the line electrode 150.

The fine dust introduction cover 135 may cover the opening formed at one side of the case 110 and may have an introduction hole 137 through which the fine dust is introduced. Here, the fine dust introduction cover 135 may allow the fine dust to pass therethrough but may filter foreign materials having a larger size than the introduction hole 137.

One of the first voltage and the second voltage may be a ground voltage and the other may be a positive voltage, but aspects of the present invention are not limited thereto. For example, the first voltage may be a negative voltage and the second voltage may be a ground voltage, or the first voltage may be a ground voltage and the second voltage may be a positive voltage or a negative voltage. Alternatively, one of the first voltage and the second voltage may be a positive voltage and the other may be a negative voltage. Otherwise, both of the first voltage and the second voltage may be positive voltages or negative voltages. A voltage difference between the [symbol] first voltage and the second voltage may be as much as the fine dust can be electrically charged.

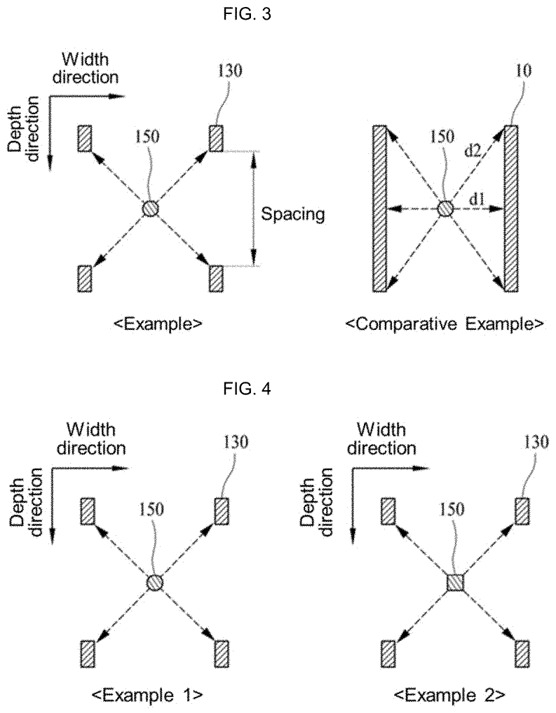

FIG. 3 is a schematic cross-sectional view illustrating arrangement of line electrodes and beam electrodes in the charger according to an embodiment of the present invention and arrangement of electrodes in a charger according to Comparative Example.

In Comparative Example, the charger includes line electrodes 150 and plate electrodes 10, which are disposed inside the case 110 without spacing. In this case, charging of fine dust occurs between the line electrodes 150 and the plate electrodes 10.

The smaller resistance, the more discharge current flows. In Comparative Example, the current intensively flows through regions between the line electrode 150 and the plate electrode 10, which are spaced a smallest distance d1 apart from each other, and a discharge current having a relatively small magnitude may flow through a region between the line electrode 150 and the plate electrode 10, which are spaced a greater distance d2 than the distance d1 apart from each other. Accordingly, since the fine dust is highly likely to be intensively charged at the region between the line electrode 150 and the plate electrode 10 spaced the smallest distance d1 apart from each other, only some of the total introduced fine dust may be electrically charged.

However, in Example of the present invention, the plurality of beam electrodes 130 are spaced apart from each other to then be disposed inside case 110, and charging of fine dust occurs between the line electrode 150 and the beam electrodes 130. In this case, currents flow between the plurality of beam electrodes 130 and the line electrode 150, which are spaced apart from each other, and there are many discharge paths therebetween, thereby increasing the fine dust charging probability, compared to Comparative Example. That is to say, if distances between the line electrode 150 and each of the plurality of beam electrodes 130 are equal to each other, fine dust charging may occur between four beam electrodes 130 and the line electrode 150, thereby increasing the fine dust charging efficiency, compared to Comparative Example.

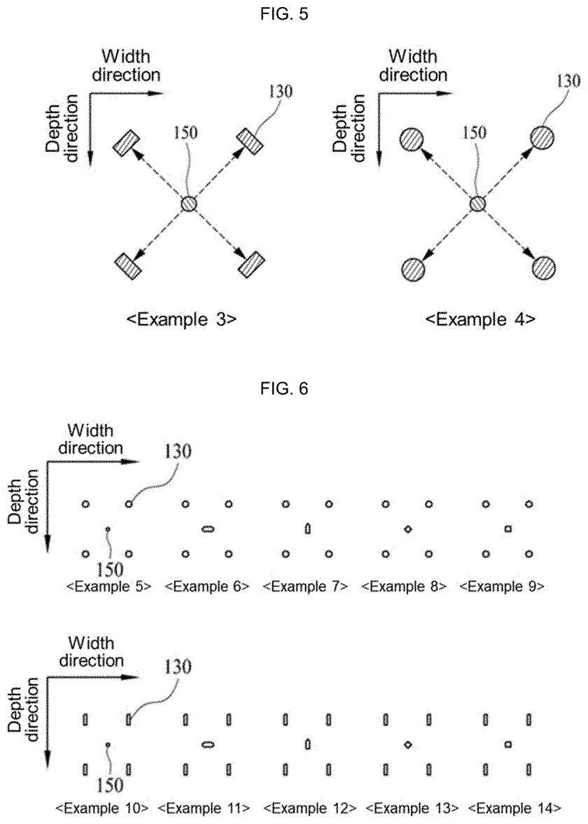

FIGS. 4 and 5 are schematic cross-sectional views illustrating Examples 1 to 4 of beam electrodes 130 and a line electrode 150 in the charger according to an embodiment of the present invention.

In Examples 1 and 2, corners of the beam electrodes 130 face the line electrode 150. However, in Examples 3 and 4, corners of the beam electrodes 130 may not face the line electrode 150, or the beam electrodes 130 may be shaped to have no corners.

Fine dust charging may be performed more smoothly in Examples 1 and 2 than in Examples 3 and 4. That is to say, since electrical charges tend to be focused on corners of a conductor, the current may smoothly flow between the corners of the beam electrodes 130 and the line electrode 150. Therefore, like in Examples 1 and 2, if the corners of the beam electrodes 130 face the line electrode 150, fine dust charging may be smoothly performed between the beam electrodes 130 and the line electrode 150.

In addition, like in Example 2, if the line electrode 150 is also shaped to have corners and faces corners of the beam electrodes 130, fine dust charging may be more smoothly performed than in Example 1.

Meanwhile, as shown in FIG. 6, the beam electrodes 130 may have rectangular sectional shapes, and the line electrode 150 may have polygonal shapes, like in Examples 6 to 9. That is to say, the line electrodes 150 may have hexagonal and pentagonal shapes, respectively, like in Examples 6 and 7, and may have rectangular sectional shapes, respectively, like in Examples 8 and 9. Here, the line electrode 150 of Example 6 may have two peaks for forming an acute angle, and the line electrode 150 of Example 7 may have one peak for forming an acute angle. Since electrical charges tend to be focused on sharp regions of a conductor, the charges may be concentrated on the peaks of the sectional shape of the line electrode 150, which form an acute angle. Accordingly, charging may be intensively performed between the peak regions of the line electrode 150 and the beam electrodes 130.

In Examples 10 to 14, the beam electrodes 130 may have circular or oval sections and may be in forms of conductive wires. The line electrodes 150 of Examples 10 to 14 may have the same shapes as those of Examples 6 to 9, respectively.

Meanwhile, the case 110 may include beam electrode insertion parts 111 protruding toward the beam electrodes 130, as shown in FIG. 2. Here, at least one or more of the plurality of beam electrodes 130 may be inserted into grooves of the beam electrode insertion parts 111. The beam electrode insertion parts 111 may be connected to one another by connection members 113 and 115.

The connection members 113 and 115 may extend along depth and width directions of the case 110, and the beam electrode insertion parts 111 may be connected and drawn at interconnection regions of the connection members 113 extending in the depth direction and the connection members 115 extending in the width direction. Since the beam electrodes 130 are inserted into the beam electrode insertion parts 111, positions of the beam electrodes 130 may be fixed.

The filtering device according to an embodiment of the present invention may further include the fine dust introduction cover 135 to allow fine dust to be introduced thereto. In addition, the fine dust introduction cover 135 may have the introduction hole 137 through which the fine dust is introduced and may be disposed above the beam electrodes 130 to cover the opening of the case 110. The fine dust introduction cover 135 may perform a pre-filtering operation of pre-filtering foreign materials or dust having relatively large sizes.

The case 110 may include holding ledges 117 to prevent the fine dust introduction cover 135 from moving in the depth direction of the case 110, as shown in FIG. 2. The holding ledges 117 may protrude from the interior surface of the case 110 in a length direction. Accordingly, ends of the fine dust introduction cover 135 and the second connection parts 133 may be suspended on the holding ledges 117.

If the second connection parts 133 are suspended on the holding ledges 117, the beam electrodes 130 positioned lower than the second connection parts 133 may be interfered by the holding ledges 117, so that passing grooves are formed in the holding ledges 117 to allow at least one or more of the plurality of beam electrodes 130 to pass therethrough.

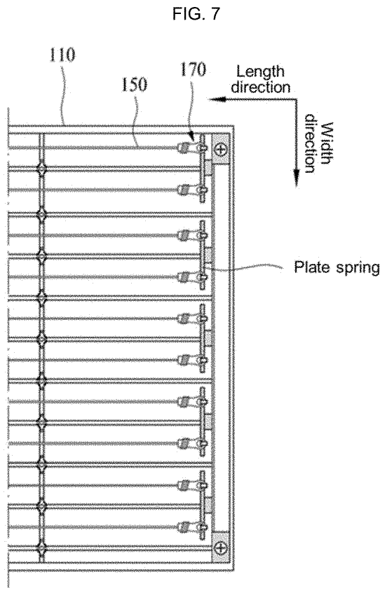

FIG. 7 is a plan view illustrating portions of elastic parts 170 of the filtering device according to an embodiment of the present invention. For convenient explanation, the holding ledges 117 shown in FIG. 2 and peripheral components thereof are not shown in FIG. 7. Referring to FIG. 7, the elastic parts 170 are fixed to the interior surface of the case 110, and the line electrodes 150 may be connected to the elastic parts 170. The elastic parts 170 may maintain tension of the line electrodes 150.

However, if the tension of the line electrodes 150 is not maintained, unlike in Examples of the present invention, sagging of the line electrodes 150 may occur. If sagging of the line electrodes 150 occurs, the distances between the beam electrodes 130 and the line electrodes 150 may vary, so that charging of fine dust may not be smoothly performed. Each of the [symbol] elastic parts 170 may include a plate spring fixed to the widthwise interior surface of the case 110. If the elastic parts 170 include coil-type springs having variable lengths, unlike in Examples of the present invention, sagging and tugging of the line electrodes 150 may be repeated, thereby constantly varying distances between the beam electrodes 130 and the line electrodes 150. Accordingly, resistances may also be varied depending on the distances between the beam electrodes 130 and the line electrodes 150, thereby changing charging performances. Since a length variation of a plate spring is smaller than that of a coil spring, it is possible to prevent the line electrodes 150 from sagging by maintaining the tension of the line electrodes 150, thereby reducing distance variations between the line electrodes 150 and the beam electrodes 130.

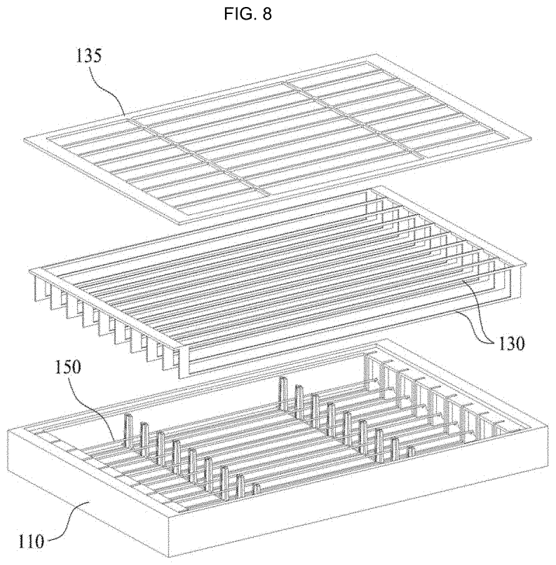

FIG. 8 is an exploded perspective view illustrating that line electrodes fixed to a case of the charger according to an embodiment of the present invention.

Referring to FIG. 8, the line electrodes 150 are positioned between the beam electrode insertion parts 111 having the beam electrodes 130 inserted thereinto. Accordingly, the line electrodes 150 may be positioned between a pair of beam electrodes and another pair of beam electrodes disposed in a depth direction of the case 110.

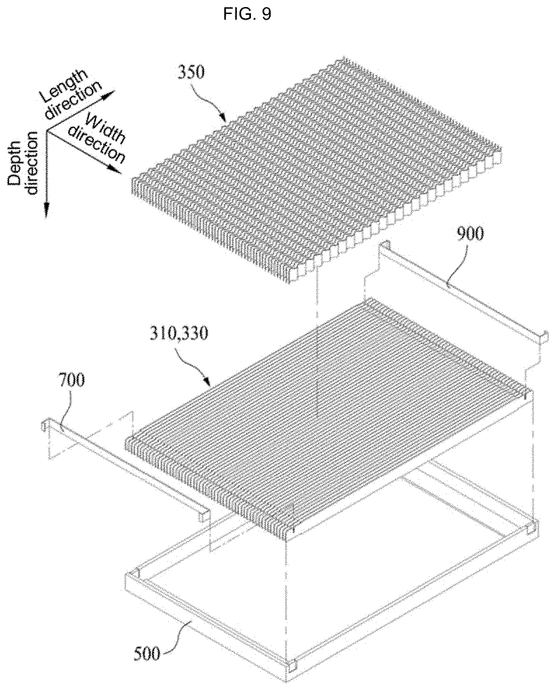

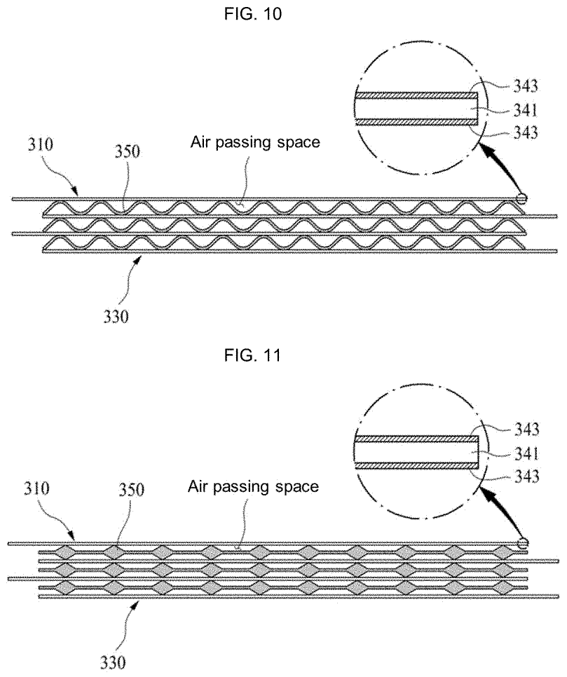

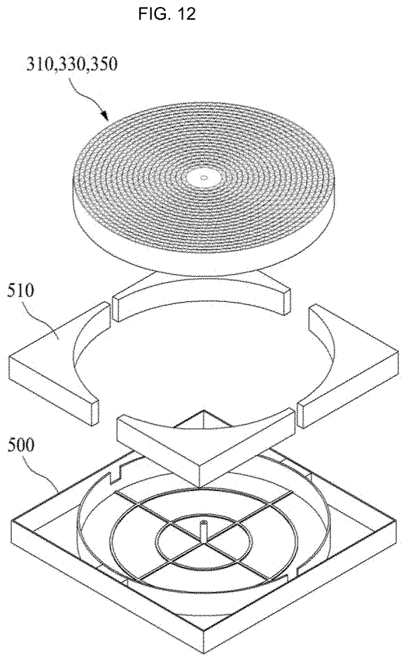

FIG. 9 is an exploded perspective view of a dust collector 300 according to an embodiment of the present invention, and FIGS. 10 and 11 are schematic cross-sectional views illustrating arrangements of a first dust collecting electrode 310, a second dust collecting electrode 330 and a dielectric spacer 350 in the dust collector according to an embodiment of the present invention.

Referring to FIGS. 9 to 11, the dust collector 300 includes a first dust collecting electrode 310, a second dust collecting electrode 330 and a dielectric spacer 350 for forming air passing spaces. A first dust collecting voltage is applied to the first dust collecting electrode 310, and a second dust collecting voltage is applied to the second dust collecting electrode 330 to generate a voltage difference with the first dust collecting electrode 310. For example, one of the first dust collecting voltage and the second dust collecting voltage applied to the first dust collecting electrode 310 and the second dust collecting electrode 330 may be a positive voltage, and the other may be a ground voltage or a negative voltage. The first and second dust collecting electrodes 310 and 330 may function as capacitors, and an attractive force or a repulsive force is applied to fine dust according to the polarity of charged fine dust to make the charged fine dust stick to the first and second dust collecting electrodes 310 and 330, thereby achieving duct collection.

The dielectric spacer 350 is disposed between the first dust collecting electrode 310 and the second dust collecting electrode 330 and increases a dust collecting capability as a dielectric. The dielectric spacer 350 may space the first dust collecting electrode 310 and the second dust collecting electrode 330 apart from each other and may form the air passing space along which the air can move.

Meanwhile, unlike in Examples of the present invention, if the entire spacings between the first dust collecting electrode 310 and the second dust collecting electrode 330 are all filled with a dielectric, it is difficult for the fine dust to be introduced to the spacings between the first dust collecting electrode 310 and the second dust collecting electrode 330, so that the fine dust may not be smoothly collected. In addition, if spacings are created between the first dust collecting electrode 310 and the second dust collecting electrode 330 without a dielectric, the dust collecting capability may be reduced.

In the dust collector 300 according to an embodiment of the present invention, the dielectric spacer 350 serves as a dielectric and the distance between the first dust collecting electrode 310 and the second dust collecting electrode 330 is maintained, thereby smoothly collecting the fine dust.

As shown in FIG. 10, the dielectric spacer 350 is disposed to contact both surfaces of the first dust collecting electrode 310 and to contact both surfaces of the second dust collecting electrode 330. Accordingly, the first dust collecting electrode 310, the dielectric spacer 350, the second dust collecting electrode 330, the dielectric spacer 350, the first dust collecting electrode 310, . . . may be arranged in that order in the dust collector according to an embodiment of the present invention.

As described above, since the dielectric spacer 350 contacts both surfaces of each of the first dust collecting electrode 310 and the second dust collecting electrode 330, the volume of the dust collector 300 can be reduced. If the first dust collecting electrode 310, the dielectric spacer 350, the second dust collecting electrode 330, the first dust collecting electrode 310, the dielectric spacer 350, the second dust collecting electrode 330 . . . are arranged in that order, unlike in the dust collector according to an embodiment of the present invention, the numbers of the first dust collecting electrodes 310 and the second dust collecting electrodes 330 are increased, thereby undesirably increasing the volume of the dust collector 300.

Meanwhile, a width of the dielectric spacer 350 may be ¾ times greater than or equal to that of the first dust collecting electrode 310 and may be 3/2 times equal to or less than that of the second dust collecting electrode 330. If the width of the dielectric spacer 350 is ¾ times smaller than that of the first dust collecting electrode 310 or the second dust collecting electrode 330, dust collection may not be smoothly achieved. If the width of the dielectric spacer 350 is 3/2 times greater than that of the first dust collecting electrode 310 or the second dust collecting electrode 330, the dust collecting case (500 of FIG. 8) may become excessively bulky.

The dielectric spacer 350 may include a protrusion part protruding toward at least one of the first and second dust collecting electrodes 310 and 330, thereby forming spacings. For example, as shown in FIG. 10, the dielectric spacer 350 has a pleated shape, thereby forming the spacings between the first dust collecting electrode 310 and the second dust collecting electrode 330 and serving as a dielectric. In addition, as shown in FIG. 11, the dielectric spacer 350 includes protrusion parts protruding toward the first dust collecting electrode 310 and the second dust collecting electrode 330, thereby forming the spacings between the first dust collecting electrode 310 and the second dust collecting electrode 330 and serving as a dielectric.

As shown in FIGS. 10 and 11, each of the first dust collecting electrode 310 and the second dust collecting electrode 330 may include a conductive layer 343 attached to both surfaces of a base plate 341. The base plate 341 may be made of a flexible material, such as polyethylene phthalate (PET). The attachment of the conductive layer 343 may be achieved by attaching a conductive sheet using a conductive adhesive or depositing a conductive material on both surfaces of the base plate 341, but aspects of the present invention are not limited thereto.

Since the conductive layer 343 is formed on both surfaces of the base plate 341, the first dust collecting electrode 310, the dielectric spacer 350, the second dust collecting electrode 330, the dielectric spacer 350, the first dust collecting electrode 310, . . . may be arranged in that order, as described above with reference to FIGS. 10 and 11.

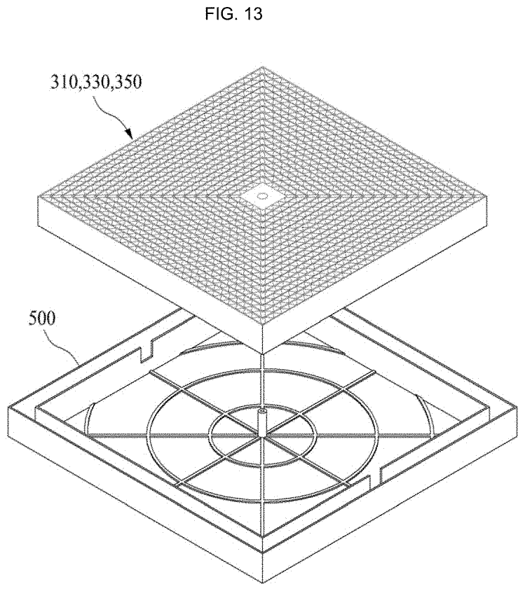

FIGS. 12 and 13 are exploded perspective views illustrating modified examples of the dust collector according to an embodiment of the present invention.

Referring to FIGS. 12 and 13, the first dust collecting electrode 310, the second dust collecting electrode 330 and the dielectric spacer 350 may be rolled in roll types. The roll types may be circular or rectangular. Accordingly, one elongated dielectric spacer 350 may be disposed between one elongated first dust collecting electrode 310 and one elongated second dust collecting electrode 330.

Referring to FIG. 12, the dust collector may further include a filling part 510 for filling spacings between the dust collecting case 500 and each of the roll-type first dust collecting electrode 310 and the roll-type second dust collecting electrode 330. Therefore, rolls of the first dust collecting electrode 310 and the second dust collecting electrode 330 may be stably maintained, and positions of the first dust collecting electrode 310 and the second dust collecting electrode 330 may be fixed.

Meanwhile, as shown in FIG. 9, a plurality of first dust collecting electrodes 310, a plurality of second dust collecting electrodes 330 and a plurality of dielectric spacers 350 may be mounted in the dust collecting case 500. The plurality of first dust collecting electrodes 310 and the plurality of second dust collecting electrodes 330 may be alternately arranged along a width direction of the dust collecting case 500. Therefore, as described above with reference to FIGS. 10 and 11, the first dust collecting electrode 310, the dielectric spacer 350, the second dust collecting electrode 330, the dielectric spacer 350, the first dust collecting electrode 310, . . . may be arranged in that order.

Polarities of the first dust collecting voltage and the second dust collecting voltage respectively applied to the first dust collecting electrode 310 and the second dust collecting electrode 330 may be reversed. For example, in the middle of applying a positive voltage and a negative voltage to the first dust collecting electrode 310 and the second dust collecting electrode 330, respectively, voltage polarities may be reversed so that a negative voltage and a positive voltage are applied to the first dust collecting electrode 310 and the second dust collecting electrode 330, respectively.

The charged fine dust is attached to the first and second dust collecting electrodes 310 and 330, and with the passage of time, it may become difficult to separate the attached charged fine dust from the first and second dust collecting electrodes 310 and 330 due to oil or sticky substance. To avoid this, when necessary, polarities of the first and second dust collecting voltages may be reversed, thereby easily separating the attached fine dust from the first and second dust collecting electrodes 310 and 330. In order to easily separate the fine dust from the first and second dust collecting electrodes 310 and 330, in addition to the reversing of polarities, voltage magnitudes may be varied such that a high-potential first dust collecting voltage and a low-potential second dust collecting voltage may first be applied to the first dust collecting electrode 310 and the second dust collecting electrode 330, and a low-potential first dust collecting voltage and a high-potential second dust collecting voltage may then be applied to the first dust collecting electrode 310 and the second dust collecting electrode 330.

In addition, as shown in FIG. 9, the filtering device according to an embodiment of the present invention may further include a first bus bar 700 and a second bus bar 900. The first bus bar 700 may connect a plurality of first dust collecting electrodes 310 to supply the first dust collecting voltage, and the second bus bar 900 may connect a plurality of second dust collecting electrodes 330 to supply the second dust collecting voltage. Here, the first and second bus bars 700 and 900 may be fixed to an exterior surface of the dust collecting case 500.

Meanwhile, a resistor may be connected to at least one of the beam electrode 130 and the line electrode 150 of the charger 100. If the resistor is connected to the beam electrode 130, the magnitude of the first voltage may be adjusted according to the magnitude of the resistor connected to the beam electrode 130. If the resistor is connected to the line electrode 150, the magnitude of the second voltage may be adjusted according to the magnitude of the resistor connected to the line electrode 150. Similarly, the resistor may be connected to at least one of the first dust collecting electrode 310 and the second dust collecting electrode 330 of the dust collector 300. Therefore, the magnitudes of the first dust collecting voltage and the second dust collecting voltage may be adjusted according to the magnitude of the resistor.

The magnitude of voltage may be so adjusted as not to cause electric shocks to users, installers or maintenance/repair technicians by connecting the resistor in the above-described manner. In addition, if the magnitude of power externally applied to the filtering device according to an embodiment of the present invention is excessively high, it can be appropriately lowered.

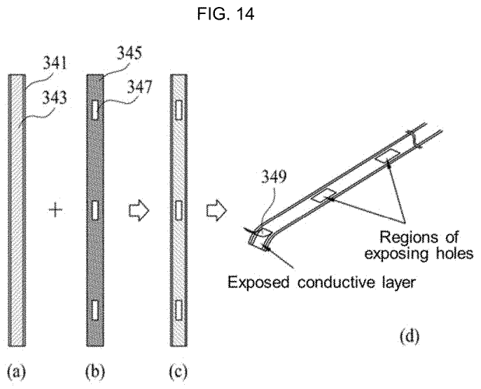

FIG. 14 is a view illustrating modified examples of a first dust collecting electrode 310 and a second dust collecting electrode 330 of the dust collector according to an embodiment of the present invention.

Referring to FIG. 14, each of the first and second dust collecting electrodes 310 and 330 may include a base plate 341, and a conductive layer 343 and an adhesion layer 345 having exposing holes 347 sequentially formed on the base plate 341. Since there is no adhesive material in regions of the exposing holes 347, the conductive layer 343 may be exposed through the exposing holes 347 when the adhesion layer 345 is formed on the conductive layer 343. The conductive layer 343 is first formed on the base plate 341, as shown in FIG. 14 (a), the adhesion layer 345 having the separately provided exposing holes 347 formed thereon is then prepared, as shown in FIG. 14(b), and the structure shown in FIG. 14 (a) and the structure shown in FIG. 14 (b) are combined to fabricate the first and second dust collecting electrodes 310 and 330, as shown in FIG. 14 (c).

Next, a film 349 may be formed on the adhesion layer 345, as shown in FIG. 14 (d). Cutting lines may be formed at regions of the film 349 corresponding to the exposing holes 347. When necessary, the regions of the film 349 may be cut along the cutting lines, thereby exposing the conductive layer 343.

Exposed regions of the conductive layer 343 are formed in such a manner because lengths of the first dust collecting electrode 310 and the second dust collecting electrode 330 vary according to the size of the filtering device according to the embodiment of the present invention. For example, if the first and second dust collecting electrodes 310 and 330 are rolled in roll types, as shown in FIGS. 11 and 12, the lengths of the first and second dust collecting electrodes 310 and 330 should be changed according to the roll sizes or design conditions. A process of cutting the first dust collecting electrode 310 and the second dust collecting electrode 330 may be performed according to the lengths set during the fabrication process of the first dust collecting electrode 310 and the second dust collecting electrode 330. The cutting process may be performed by cutting the regions of the exposing holes 347 shown in FIG. 14, and the conductive layer 343 may be exposed by removing the film 349 in the cut regions along the cutting lines. Thereafter, wires for supplying the exposed conductive layer 343 with the first dust collecting voltage or the second dust collecting voltage may be connected to the conductive layer 343.

However, if regions of the conductive layer 343 connected to the wires are set in a state in which the lengths of the first dust collecting electrode 310 and the second dust collecting electrode 330 depending on the sizes or design conditions have yet to be determined, the set regions may not match with regions for the wires required by the first dust collecting electrode 310 and the second dust collecting electrode 330, which cut in a later stage. To avoid this, multiple regions of the exposing holes 347, as shown in FIG. 14, may be first formed even if the sizes or design conditions have yet to be determined, and after the sizes or design conditions are determined, the regions of the exposing holes 347 of the first dust collecting electrode 310 and the second dust collecting electrode 330 having appropriate lengths may then be cut, thereby facilitating the wire connection.

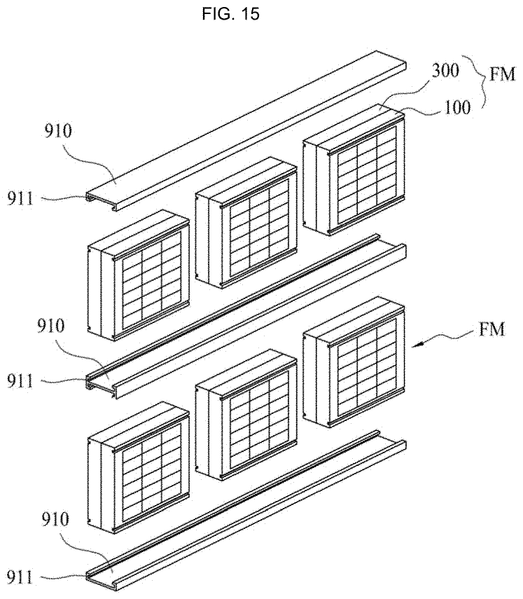

FIG. 15 is an exploded perspective view illustrating an array structure of the filtering device according to an embodiment of the present invention. Referring to FIG. 15, the filtering device may include a plurality of filtering modules FM's and connection rails 910. Each filtering module FM may include a charger 100 and a dust collector 300 overlapping each other, and the connection rails 910 may connect the plurality of filtering modules FM's to one another. To this end, guiding grooves 911 may be formed in the connection rails 910 to allow the filtering modules FM's to be inserted thereinto and to slidably move. First ends and second ends of the plurality of filtering modules FM's may be inserted into the guiding grooves 911 of the connection rails 910 vertically spaced apart from each other and may then slidably move along the guiding grooves 911, thereby arranging the filtering modules FM's at appropriate positions.

As described above, the plurality of filtering modules FM are connected to one another by the connection rails 910, thereby filtering fine dust over a wide area. In addition, the number of filtering modules FM's connected to one another may be changed as desired by the user. Therefore, the filtering device according to the present invention may have increased installation flexibility according to the place or conditions.

Charging contact terminals for applying first and second voltages to the chargers 100 of the filtering modules FM's may be formed on interior surfaces of the connection rails 910. The plurality of beam electrodes 130 may be connected to a common node, which may contact the charging contact terminal for applying the first voltage to the plurality of beam electrodes 130. In addition, the plurality of line electrodes 150 may also be connected to the common node, which may contact the charging contact terminal for applying the second voltage to the line electrodes 150. Similarly, dust collecting contact terminals for applying first and second dust collecting voltages to the dust collectors 300 of the filtering modules FM's may be formed on the interior surfaces of the connection rails 910.

The charging contact terminals and the dust collecting contact terminals may be insulated from each other to prevent the charging contact terminals and the dust collecting contact terminals from being short-circuited. The connection rails 910 may be made of, for example, nonconductors, and the charging contact terminals and the dust collecting contact terminals may be spaced apart from each other. Since the charging contact terminals and the dust collecting contact terminals are formed on the interior surfaces of the connection rails 910, as described above, the number of wires for applying the first and second voltages and the first and second dust collecting voltages to the plurality of filtering modules FM's is reduced, thereby simplifying the structure of the filtering device and increasing feasibility of facilitated installation.

Although the present invention has been described with respect to the foregoing embodiments, these embodiments are set forth for illustrative purposes and do not serve to limit the invention. Those skilled in the art will readily appreciate that many modifications and variations can be made, without departing from the spirit and scope of the invention as defined in the appended claims, and such modifications and variations are encompassed within the scope and spirit of the present invention.

1. A charger employed to a filtering device for removing fine dust and charging the fine dust, the charger comprising:
a case having one side, through which fine dust is introduced;
a plurality of beam electrodes inserted into the case and spaced apart from each other along a depth direction of the case wherein a first voltage is applied thereto; and
line electrodes arranged inside the case and spaced apart from the plurality of beam electrodes, respectively, so that a second voltage is applied thereto to generate a voltage difference with the beam electrodes,
wherein the fine dust is charged between the beam electrodes and the line electrodes.

2. The charger of claim 1, wherein the plurality of beam electrodes are connected to a plurality of first connection parts, and the plurality of first connection parts are connected to second connection parts in a state in which the first connection parts are spaced apart from each other to then be arranged along a width direction of the case.

3. The charger of claim 1, wherein the case includes beam electrode insertion parts protruding toward the beam electrodes, and at least one or more of the plurality of beam electrodes are inserted into grooves of the beam electrode insertion parts.

4. The charger of claim 3, further comprising a fine dust introduction cover having an introduction hole through which the fine dust is introduced and disposed above the beam electrodes to cover an opening of the case, wherein the case includes holding ledges for preventing the fine dust introduction cover from moving along a depth direction of the case, wherein passing grooves are formed in the holding ledges to allow at least one or more of the plurality of beam electrodes to pass therethrough.

5. The charger of claim 1, wherein elastic parts are fixed to the interior surface of the case, and the line electrodes are connected to the elastic parts.

6. A dust collector employed to a filtering device for removing fine dust and collecting the charged fine dust, the dust collector comprising:
a first dust collecting electrode to which a first dust collecting voltage is applied;
a second dust collecting electrode to which a second dust collecting voltage is applied to generate a voltage difference with the first dust collecting electrode; and
a dielectric spacer which is disposed between the first dust collecting electrode and the second dust collecting electrode to space the first dust collecting electrode and the second dust collecting electrode apart from each other and to serve as a dielectric,
wherein the dielectric spacer is disposed to contact both surfaces of the first dust collecting electrode and both surfaces of the second dust collecting electrode.

7. The dust collector of claim 6, wherein the dielectric spacer includes protrusion parts protruding toward at least one of the first dust collecting electrode and the second dust collecting electrode.

8. The dust collector of claim 6, wherein each of the first dust collecting electrode and the second dust collecting electrode has a conductive layer attached to both surfaces of a base plate.

9. The dust collector of claim 6, further comprising a dust collecting case in which a plurality of first dust collecting electrodes, a plurality of second dust collecting electrodes and a plurality of dielectric spacers are mounted, wherein the plurality of first dust collecting electrodes and the plurality of second dust collecting electrodes are alternately arranged along a width direction of the dust collecting case.

10. The dust collector of claim 9, further comprising:
a first bus bar connecting the plurality of first dust collecting electrodes to supply the plurality of first dust collecting electrodes with the first dust collecting voltage; and
a second bus bar connecting the plurality of second dust collecting electrodes to supply the plurality of second dust collecting electrodes with the second dust collecting voltage.

11. The dust collector of claim 6, wherein the conductive layer is formed on the base plate of each of the first dust collecting electrode and the second dust collecting electrode, an adhesion layer is formed on the conductive layer, a film is formed on the adhesion layer, exposing holes are formed in the adhesion layer, and cutting lines are formed in regions of the film corresponding to the exposing holes.

12-13. (canceled)

14. A filtering device for removing fine dust, the filtering device comprising:
a charger including a case having one side, through which fine dust is introduced, a plurality of beam electrodes inserted into the case and spaced apart from each other along a depth direction of the case wherein a first voltage is applied thereto and line electrodes arranged inside the case and spaced apart from the plurality of beam electrodes, respectively, so that a second voltage is applied thereto to generate a voltage difference with the beam electrodes, wherein the fine dust is charged between the beam electrodes and the line electrodes; and
a dust collector including a first dust collecting electrode to which a first dust collecting voltage is applied, a second dust collecting electrode to which a second dust collecting voltage is applied to generate a voltage difference with the first dust collecting electrode and a dielectric spacer which is disposed between the first dust collecting electrode and the second dust collecting electrode to space the first dust collecting electrode and the second dust collecting electrode apart from each other and to serve as a dielectric, wherein the dielectric spacer is disposed to contact both surfaces of the first dust collecting electrode and both surfaces of the second dust collecting electrode.

15. The filtering device of claim 14, further comprising connection rails including a plurality of filtering modules each having the charger and the dust collector overlapping each other and connecting the plurality of filtering modules to one another, wherein guiding grooves are formed in the connection rails to allow the filtering modules to be inserted thereinto and to slidably move.

16. The filtering device of claim 14, wherein the plurality of beam electrodes are connected to a plurality of first connection parts, and the plurality of first connection parts are connected to second connection parts in a state in which the first connection parts are spaced apart from each other to then be arranged along a width direction of the case.

17. The filtering device of claim 14, wherein the case includes beam electrode insertion parts protruding toward the beam electrodes, and at least one or more of the plurality of beam electrodes are inserted into grooves of the beam electrode insertion parts.

18. The filtering device of claim 17, further comprising a fine dust introduction cover having an introduction hole through which the fine dust is introduced and disposed above the beam electrodes to cover an opening of the case, wherein the case includes holding ledges for preventing the fine dust introduction cover from moving along a depth direction of the case, wherein passing grooves are formed in the holding ledges to allow at least one or more of the plurality of beam electrodes to pass therethrough.

19. The filtering device of claim 14, wherein elastic parts are fixed to the interior surface of the case, and the line electrodes are connected to the elastic parts.

20. The filtering device of claim 14, wherein the dielectric spacer includes protrusion parts protruding toward at least one of the first dust collecting electrode and the second dust collecting electrode.
